(19) United States
(12) Patent Application Publication
(10) Pub. No.: US 2012/0199013 A1
(43) Pub. Date: Aug. 9, 2012

(54) INTEGRATED WINE TAP AND AERATOR APPARATUS

(76) Inventor: Roberto Gutierrez, El Paso, TX (US)

(21) Appl. No.: 13/269,196

(22) Filed: Oct. 7, 2011

Related U.S. Application Data
(60) Provisional application No. 61/440,018, filed on Feb. 7, 2011.

(51) Int. Cl. B01F 3/04

(52) U.S. Cl. 99/323.1

(57) ABSTRACT

An apparatus for aerating wine includes a tap assembly connected to a wine container that maintains wine. Such an apparatus can further include a spout with at least one venturi, wherein said venturi aerates wine by puffing air into said wine. The wine container can be configured as a wine box with a wine bag. The spout with the venturi can be integrated with the tap assembly. Wine from the wine container flows generally through the spout. The tap assembly can include a knob that controls a flow of wine from the wine container.

### CROSS-REFERENCE TO PROVISIONAL APPLICATION

This patent application claims the benefit under 35 U.S.C. §119(e) of U.S. Provisional Application Ser. No. 61/440,018 entitled, “Integrated Wine Tap and Aerator Apparatus,” which was filed on Feb. 7, 2011 and is incorporated herein by reference in its entirety.

### TECHNICAL FIELD

Embodiments are generally related to an apparatus for aerating wine. Embodiments also relate to the field of wine aerating devices having an aerating tap. Embodiments additionally relate to an integrated wine tap and aerator apparatus for use with a wine container such as, for example, a box of wine, also referred to as “boxed wine”.

### BACKGROUND OF THE INVENTION

Wine is typically stored in sealed bottles which prevent the deterioration of the wine caused by extended contact with ambient air. Various techniques permit the dispensal of a wine sample from a bottle. To enjoy the bouquet and flavor of a fine wine, wine connoisseurs knew that the wine should be allowed to aerate or “breathe” before human consumption. Heretofore, this was done by merely opening a bottle of wine and allowing the wine to interact with the atmosphere in order to oxidize certain chemicals, such as tannins, naturally contained in the wine, which would otherwise impair the taste of the wine. This was a time consuming operation and needed to be performed well in advance of consumption of the wine. Wine was also conventionally aerated by manually decanting the wine from the wine bottle to another container. Here again, this transfer operation was time consuming and required not only a separate decanter, but also a steady hand to avoid wine spillage.

Various techniques have been developed to accelerate the reoxgenation of a wine. For example, one prior art approach discloses a wine breather apparatus for aerating wine having a motor driven oscillating coupler for connecting two wine containers to flow wine from one container to the other upon oscillating of the coupler and the containers to aerate the wine with a valve on the coupler for allowing outside air into the coupler and containers during oscillation thereof to aerate the wine.

In another prior art approach, a device for aerating wine in a bottle possesses an elongated, upright conduit with one end region immersed in the wine and an opposite end region exposed to the atmosphere is disclosed. In this particular configuration, a rotary shaft is located within and extends along the conduit. A wine blade is mounted on the shaft for drawing the wine as wine flows into the one end region in an upward direction toward the opposite end region of the conduit upon rotation of the shaft. An air blade is preferably mounted on the shaft for causing the air to move as an air stream into the opposite end region in a downward direction toward the one end region of the conduit upon rotation of the shaft. A drive rotates the shaft, the wine blades, and the air blades to propel the wine flow and the air stream against each other in a mutually countercurrent relationship and to commingle the wine flow and the air stream inside the bottle.

In yet another prior art configuration or approach, the wine aerating apparatus includes a housing for containing wine and air, a baffle positioned within the housing interior, and a valve which permits the placement of the wine into the housing interior. The housing can be inverted to mix the wine and air, and the valve prevents the leakage of wine from the housing interior. In one embodiment of the invention, an aperture such as a spout can be attached to the housing to permit the removal of the wine from the housing interior, and the valve is selectively openable to prevent a vacuum as the wine is poured from the apparatus.

The wine market in the United States, for example, has for the last few years seen the heavy presence of wine brands such as Franzia®, Almaden®, Vella®, and Black Box®, to name a few, which offer respective wines in a box presentation. The term “box of wine” or “boxed wine” would be more accurately stated as “bag of wine in a box”, as these products invariably include the use of a poly bag (typically double layered) with an integrated tap packaged inside an outer box. The outer box is designed to allow access to the tap. These brands offer a small number of wine varietals and are typically much more economical than bottled brands. There is also typically a small difference in price between “box” brands for the same type of wine. In order to differentiate the brands, various improvements have been introduced in wine box, for example, box wine with “no-drip” tap. As wine enthusiasts know, one of the most common ways of improving the taste of wine right before consumption is through aeration. Aerating devices are common and typically consist of an input receptacle for wine out of the bottle, a venturi device to pull air into the liquid, and an output spout for the aerated wine. Difficulty arises when and aerating device is integrated with the box wine.

Prior wine aerating devices are complex and difficult to incorporate with a common wine box tap. Further, some prior art wine aerating methods and configurations consume more time for aerating the wine. In some cases, the wine may not be satisfactorily aerated. Also, the aerating apparatus should allow the box-wine brands to easily differentiate themselves from their competitors. Further, the design of aerating device should be such that it can be easily integrated into the design of a common box wine tap. In an effort to address the foregoing difficulties, it is believed that the integrated wine tap and aerator apparatus, as discussed herein, can address many of the problems with traditional wine aerating devices.

### BRIEF SUMMARY

The following summary is provided to facilitate an understanding of some of the innovative features unique to the disclosed embodiment and is not intended to be a full description. A full appreciation of the various aspects of the embodiments disclosed herein can be gained by taking the entire specification, claims, drawings, and abstract as a whole.

It is, therefore, one aspect of the disclosed embodiments to provide for an apparatus for aerating wine,

It is another aspect of the disclosed embodiments to provide for a wine aerating apparatus having an aerating tap.

It is a further aspect of the present invention to provide for an integrated wine tap and aerator apparatus for use with a wine container such as, for example a box wine.

The aforementioned aspects and other objectives and advantages can now be achieved as described herein. An aerating apparatus includes an assembly of two or three plastic-injection molded components joined to a wine bag. The apparatus further includes a tap assembly and a spout with a venturi design. The wine from the bag is forced through the tap and spout. The venturi design pulls the air into the wine flow right before it exits the spout and finally produces aerated wine.

### BRIEF DESCRIPTION OF THE DRAWINGS

The accompanying figures, in which like reference numerals refer to identical or functionally-similar elements throughout the separate views and which are incorporated in and form a part of the specification, further illustrate the disclosed embodiments and, together with the detailed description of the invention, serve to explain the principles of the disclosed embodiments.

FIG. 1 illustrates a perspective view of an integrated wine tap and aerator apparatus, in accordance with the disclosed embodiments;

FIG. 2 illustrates a perspective view of an integrated wine tap and aerator apparatus installed in a wine box, in accordance with the disclosed embodiments;

FIG. 3 illustrates a sectional view of a spout with a venturi design taken along section 3-3 of integrated wine tap and aerator apparatus of FIG. 1, in accordance with the disclosed embodiments;

FIG. 4 illustrates a side view of a spout with a venturi design of FIG. 3, in accordance with the disclosed embodiments; and

FIG. 5 illustrates a flow chart depicting the process of aerating the wine by utilizing the integrated wine tap and aerator apparatus of FIG. 1, in accordance with the disclosed embodiments.

### DETAILED DESCRIPTION

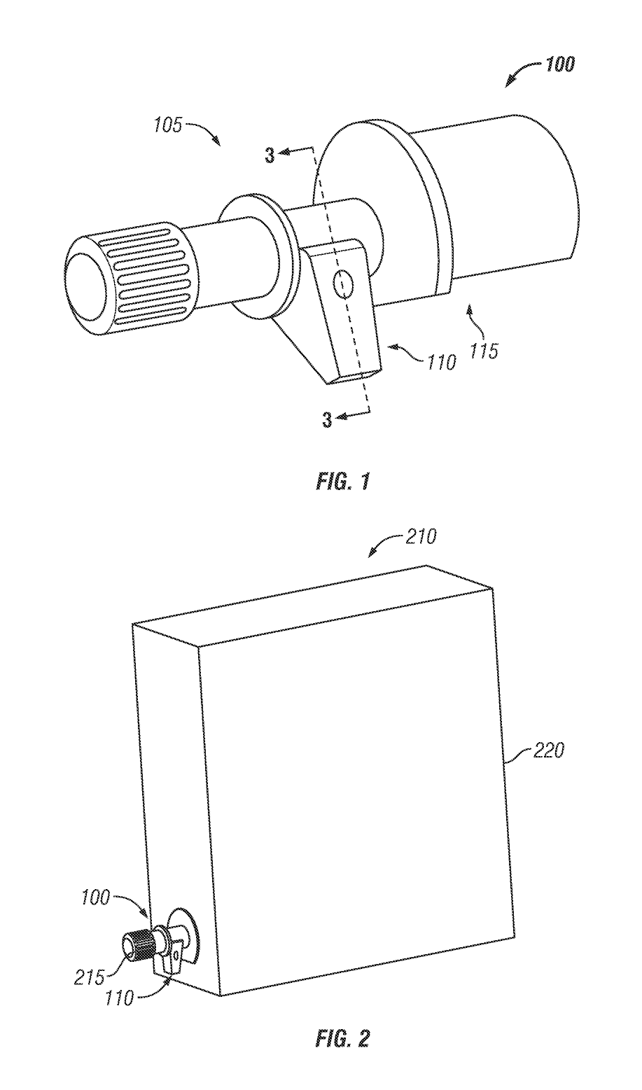

The particular values and configurations discussed in these non-limiting examples can be varied and are cited merely to illustrate at least one embodiment and are not intended to limit the scope thereof. Note that in FIGS. 1-3, identical or similar parts or elements are generally indicated by identical reference numerals.

FIG. 1 illustrates a perspective view of an integrated wine tap and aerator apparatus 100, in accordance with the disclosed embodiments. The apparatus 100 generally includes two or three plastic-injection molded components 115 that connect to a wine bag (not shown in FIG. 1). The apparatus 100 can be easily integrated into the design of a common box wine tap assembly 105.

FIG. 2 illustrates a perspective view of an integrated wine tap and aerator apparatus 100 installed in a wine box 210, in accordance with the disclosed embodiments. As indicated in FIG. 2, apparatus 100 further includes a spout 110 with a venturi design (not shown). The wine box 210 includes a poly wine bag (typically double layered) with an integrated tap assembly 105 packaged inside an outer box 220. The outer box 220 is designed to allow access to the tap. By adjusting the knob 215, the flow of wine can be controlled. As wine from the bag is forced through the tap assembly 105 and spout 110, the venturi (not shown) pulls air into the wine flow right before it exits into a glass.

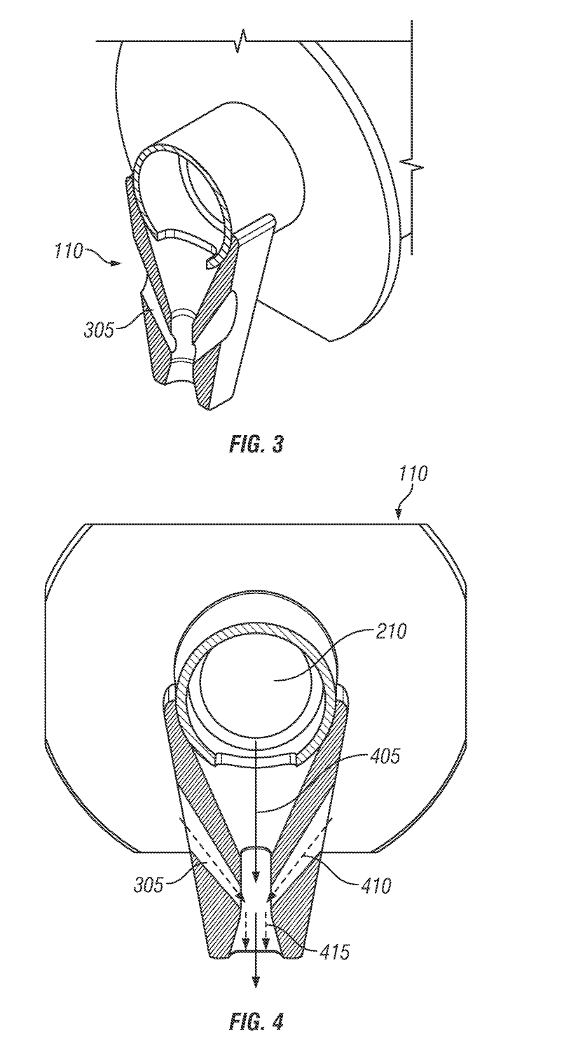

FIG. 3 illustrates a sectional view of a spout 100 with a venturi design 305 taken along section 3-3 of integrated wine tap and aerator apparatus of FIG. 1, in accordance with the disclosed embodiments.

FIG. 4 illustrates a side view of a spout with a venturi design 305 or venturi 305 of FIG. 3, in accordance with the disclosed embodiments. The venturi 305 pulls the air 410 into the wine 405 which is flowing from wine box 210. The aerated wine 415 can be collected from the spout 110 as depicted in FIG. 4 and then served.

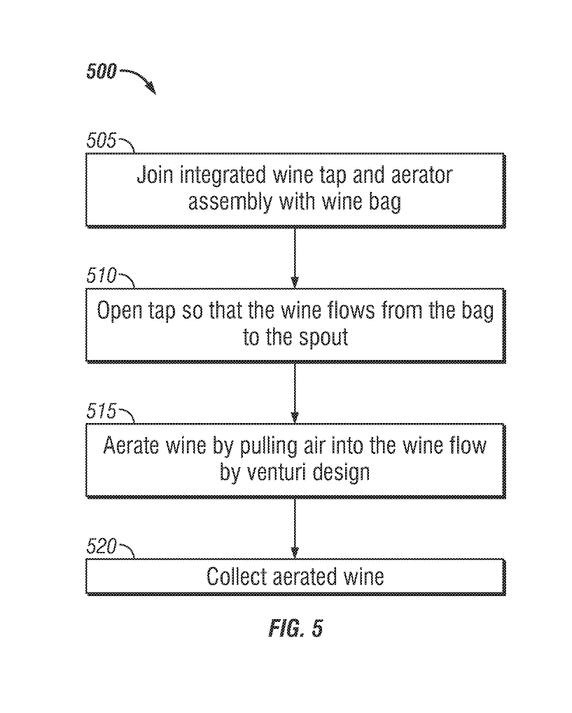

FIG. 5 illustrates a high-level flow chart of operations depicting a process 500 of aerating wine by utilizing the integrated wine tap and aerator apparatus of FIGS. 1-2, in accordance with the disclosed embodiments. As indicated at block 505, the disclosed integrated wine tap and aerator apparatus can be joined to a wine box. Then, as depicted at block 510, the knob can be adjusted so that the wine from the bag flows into the spout. The venturi design in the spout pulls the air into the wine and aerates it, as described at block 515. Finally, as illustrated at block 520, the aerated wine can be collected from the spout end and served.

Based on the foregoing, it can be appreciated that an apparatus is disclosed for aerating wine. In one embodiment, such an apparatus includes a tap assembly that can be connected to a wine container that maintains wine. Such an apparatus further can include a spout with at least one venturi, wherein said venturi aerates wine by pulling air into said wine. In some embodiments, the wine container can be configured as a wine box. In still other embodiments, such a wine box can include a wine bag. The spout with the venturi can be integrated with the tap assembly. Wine from the wine container (or wine bag or wine box in other embodiments) flows generally through the spout. The tap assembly can be configured to include a knob that controls the flow of wine from the wine container. In other embodiments, the tap assembly can include a knob that controls a flow of wine from the wine container (or wine bag or wine box in other embodiments).

It will be appreciated that variations of the above disclosed and other features and functions, or alternatives thereof, may be desirably combined into many other different systems or applications. Also, that various presently unforeseen or unanticipated alternatives, modifications, variations or improvements therein may be subsequently made by those skilled in the art which are also intended to be encompassed by the following claims.

What is claimed is:

1. An apparatus for aerating wine, comprising:
a tap assembly connected to a wine container that maintains wine; and
a spout with at least one venturi wherein said venturi aerates wine by pulling air into said wine.

2. The apparatus of claim 1 wherein said wine container comprises a wine box.

3. The apparatus of claim 2 wherein said wine box comprises a wine bag.

4. The apparatus of claim 1 wherein said spout with said venturi is integrated with said tap assembly.

5. The apparatus of claim 1 wherein wine from said wine bag flows through said spout.

6. The apparatus of claim 1 wherein said tap assembly comprises a knob that controls a flow of said wine from said wine container.

7. The apparatus of claim 3 wherein said tap assembly comprises a knob that controls a flow of said wine from said wine bag.

8. An apparatus for aerating wine, comprising:
a tap assembly connected to a wine container that maintains wine; and
a spout with at least one venturi wherein said venturi aerates wine by pulling air into said wine, wherein said spout with said venturi is integrated with said tap assembly.

9. The apparatus of claim 8 wherein said wine container comprises a wine box,

10. The apparatus of claim 8 wherein said wine box comprises a wine bag.

11. The apparatus of claim 10 wherein wine from said wine bag flows through said spout.

12. The apparatus of claim 9 wherein said tap assembly comprises a knob that controls a flow of said wine from said wine box.

13. The apparatus of claim 10 wherein said tap assembly comprises a knob that controls a flow of said wine from said wine bag.

14. An apparatus for aerating wine, comprising:
a tap assembly connected to a wine container that maintains wine; and
a spout with at least one venturi wherein said venturi aerates wine by puffing air into said wine, said tap assembly comprising a knob that controls a flow of said wine from said wine container.

15. The apparatus of claim 14 wherein said wine container comprises a wine box.

16. The apparatus of claim 15 wherein said wine box comprises a wine bag.

17. The apparatus of claim 14 wherein said spout with said venturi is integrated with said tap assembly.

18. The apparatus of claim 16 wherein wine from said wine bag flows through said spout.

19. The apparatus of claim 16 wherein said tap assembly comprises a knob that controls a flow of said wine from said wine bag.

20. The apparatus of claim 14 wherein:
said spout with said venturi is integrated with said tap assembly; and
wine from said wine bag container flows through said spout.
